(19) United States
(12) Patent Application Publication
(10) Pub. No.: US 2025/0344759 A1
(43) Pub. Date: Nov. 13, 2025

(54) Smoking Accessories

(71) Applicant: Warehouse Goods LLC, Boca Raton, FL (US)

(72) Inventors: Edward Kilduff, Hermosa Beach, CA (US); Shane Grant Blomberg, Hermosa Beach, CA (US); Scott Tryong, Hermosa Beach, CA (US); Andrew Reeves, Hermosa Beach, CA (US)

(73) Assignee: Warehouse Goods LLC, Boca Raton, FL (US)

(21) Appl. No.: 18/872,266

(22) PCT Filed: Jun. 6, 2023
(86) PCT No.: PCT/US2023/067983

§ 371 Date: Dec. 5, 2024

Related U.S. Application Data
(60) Provisional application No. 63/365,885, filed on Jun. 6, 2022.

(51) Int. Cl. A24F 3/00; B67B 7/16

(52) U.S. Cl. CPC A24F 3/00; B67B 7/16

(57) ABSTRACT

A multi-use tool, having a body having a first end and a second end, a tube defined by the body and having an outlet at the first end of the body, a receptacle defined by the body between the first end and the second end and coupled to the tube, a third tube at the first end defined by the body, a first tool at the first end, the first tool configured to connect and secure the multi-use tool to an ancillary item, and a second tool at the second end having a first tooth and a second tooth.

### CROSS-REFERENCE TO RELATED APPLICATIONS

The application claims the benefit of provisional U.S. Patent Application No. 63/365,885 filed Jun. 6, 2022, 2020 and International Application No. PCT/US2023/067983 filed Jun. 6, 2023, the contents of which are hereby incorporated in their entirety.

### FIELD

The present disclosure relates to accessories for smoking and vaping.

### BACKGROUND

This section provides background information related to the present disclosure which is not necessarily prior art.

Vapers' and smokers' items and accessories have been in use for decades. However, many of the materials enjoyed by vapers and smokers are massed produced. Accordingly, the quality of these massed produced materials is often subpar or not directed toward a person's specific desire. Therefore, there exists a need for better control over the materials and accessories employed by vapers and smokers.

For example, materials used to grind vaporizable materials can be difficult to handle and master. Many accessories are not easily assembled and, once assembled, not easily operated.

Also, it is not unusual, that vaporizers, pipes, spoons, etc. are not readily available as it they are difficult to keep near due to their size and shape. Accordingly, there is a need for a more easily transportable and storable smoking and vaping device.

There is a further need for a battery that is easy to store, operate and replace expired batteries.

### SUMMARY

This section provides a general summary of the disclosure, and is not a comprehensive disclosure of its full scope or all of its features.

An embodiment includes a multi-use tool, having a body having a first end and a second end, a tube defined by the body and having an outlet at the first end of the body, a receptacle defined by the body between the first end and the second end and coupled to the tube, a third tube at the first end defined by the body, a first tool at the first end, the first tool configured to connect and secure the multi-use tool to an ancillary item, and a second tool at the second end having a first tooth and a second tooth.

A further embodiment of an accessory is a grinder that includes a first grinding section and a second grinding section. The first grinding section may include a first plurality of teeth on a first substrate, a post at a center of the first grinding section, and a receptacle defined by the substrate and a body circumferentially attached to an edge of the substrate. The second grinding section may include a second plurality of teeth on a second substrate, a post receptacle at a center of the second grinding section and configured to receive the post, and a projection on a side of the second substrate opposite the second plurality of teeth.

A yet further embodiment of an accessory may be a battery that includes a first end and a second end, each end having at least one electrical contact, a first actuator for controlling the battery; and a second actuator for further controlling the battery.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A illustrates a bottom view of an embodiment of a smoking accessory;

FIG. 1B illustrates a top view of the embodiment of FIG. 1A;

FIG. 2 illustrates a cross-sectional view of the embodiment of FIG. 1A taken along line 2-2;

FIG. 3B illustrates a top plan view of the embodiment of FIG. 1A;

FIG. 4 illustrates an example of a further embodiment of a smoking accessory;

FIGS. 5 and 6 illustrate exploded views of the embodiment of FIG. 4;

FIG. 7 illustrates a perspective view of a section of the embodiment of FIG. 4; and

FIG. 8 illustrates a perspective view of another section of the embodiment of FIG. 4;

FIG. 9A-9E illustrate the sections illustrated in FIGS. 7 and 8 in a combined configuration; and

FIG. 9F illustrates a cross-sectional view of FIG. 9D taken along line 9F.

### DETAILED DESCRIPTION

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. As used in herein, the terms “substantially,” “about,” or at least are provided to indicate that an exact equivalence is not necessary and substitutes which perform the same work in the same way to achieve the same result are intended to fall within the scope of the discussion.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Use of a quantitative term or value is not limited to the exact amount recited. For example, presence of the term “about” indicates an intention to convey that the same result can be achieved by using a value that is not exactly that recited. Similarly, if an objective can be achieved by using less than all of a specified amount, it may be so indicated through use of the term “substantial” or “substantially.” For example, fifty percent of a value may be considered substantial when the same result can be achieved as if 100% of a value is used. If an exact amount is required in order to achieve a result, it will be specifically stated.

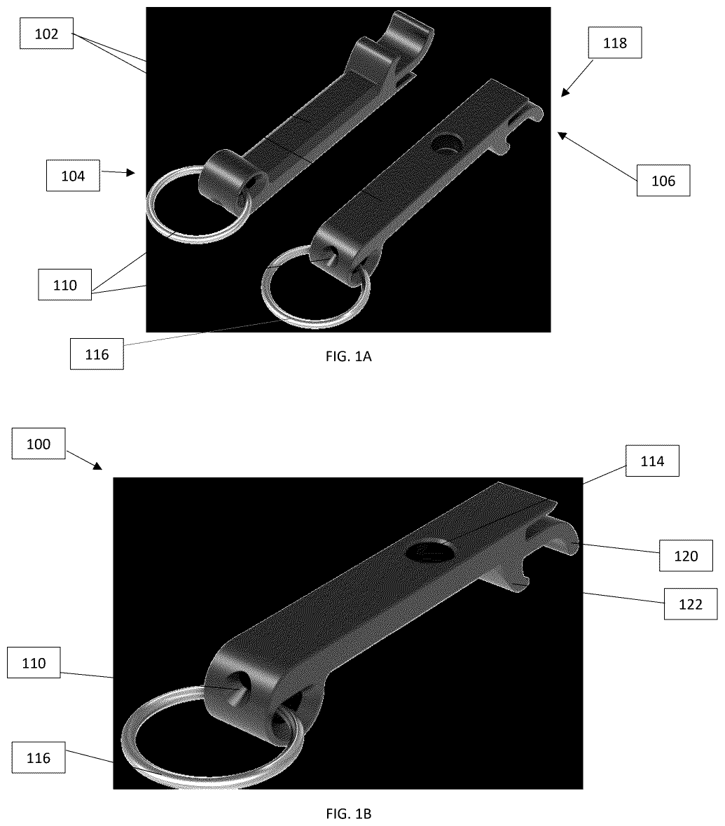

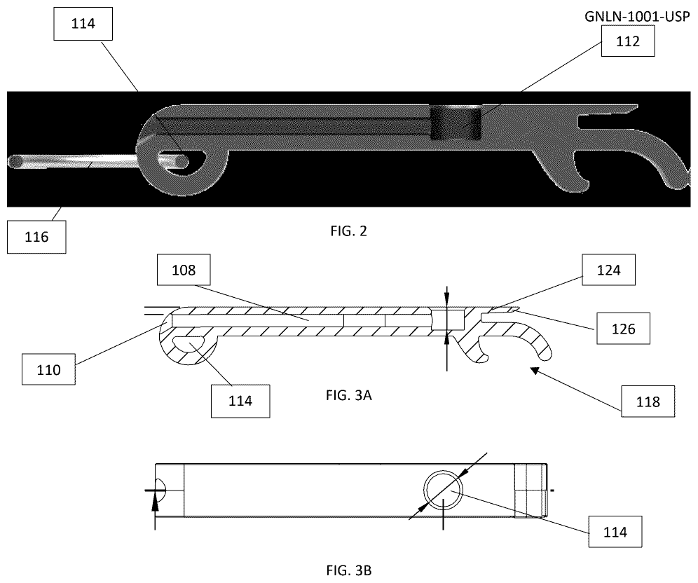

FIGS. 1A, 1B, 2, 3A, and 3B illustrate an example embodiment of multi-use tool 100. FIG. 1A includes both a top perspective view and a bottom perspective view of the multi-use tool 100. The bottom is a side of the multi-use tool 100 that opposes the top of the multi-use tool 100.

The multi-use tool may include a body 102. The body may have a first end 104 and a second end 106. A tube 108 may be defined by the body and may have an outlet 110 at the first end 104 of the body 102. A second tube 112, e.g., a receptacle, may be defined by the body 102 between the first end 104 and the second end 106 and may be coupled to the tube 108. A third tube 114 may be at the first end 104 and may be defined by the body 102.

A first tool 116 may be at the first end 104. The first tool 116 may be configured to connect and secure the multi-use tool 100 to an ancillary item, and a second tool 118 at the second end 106 having a first tooth 120 and a second tooth 122.

The multi-use tool may include a third tooth 124 at the second end 106. The third tooth 124 may be proximate to the first tooth 120 and the second tooth 122. The first tooth 120 and the third tooth 124 may define a gap between them that is as wide as a width of the body 102 and as long as the shortest of the first tooth 120 and the third tooth 124. The first tooth 120 and the second tooth 122 may be curved toward each other, while the third tooth 124 may be substantially planar.

The first tool 116 may be a ring encircled by the defined third tube 114. The second tube 112 may be a receptacle for receiving a vaporizable material. The body is configured to withstand temperatures of at least 100° F. without experiencing plastic deformation. The defined third tube 114 may be substantially orthogonal to the defined first tube 108. The defined third tube 114 may be substantially orthogonal to the defined second tube 112.

The first tool 116 may be useful in securing keys or other useful items to the multi-use tool 100. The first tooth 120 and the second tooth 122 of the defined second tool 116, may work together to release and remove bottle caps on individual sized beverage bottles, e.g., soft drinks and beer.

The third tooth 124 may be a piercing device at an end of the third tooth 124 and, accordingly, may include a sharp edge 126. The sharp edge 126 may help to open cans by piercing them. Additional sharp edges may be on the side of the third tooth 124.

The second tube 112 may hold and retain vaporizable material, which can be burned or heated to create a vapor or smoke inhalable through the second tube 112. For example, a person may apply negative pressure on the second tube 112 by placing their lips around the outlet 110 and inhaling air through the tube 108 via the outlet 110. Heat for the vaporizable material may be applied externally by placing a flame or heat source hear the third tube 114. Or, heat may be applied via an internal heating element (not shown) that at least partially surrounds the third tube 114 or is at a base of the third tube 114. A power supply (battery, solar cells, etc.) and controller may be provided in the multi-use tool to power the heating element and control operation of the multi-use tool.

A person may choose to use the second tool 118 as a bottle opener. For example, a person may grip a bottle cap with the first tooth 120 and the second tooth 122 and provide a tilting (i.e., lever) force about a point midway between the teeth to remove a cap from a bottle.

A person may use the third tooth 124 as a piercing device. For example, the third tooth 124 can be used to open a pierce a can, open an envelope, or pierce a different object.

The third tooth 124 may be plastic, metal or a combination thereof. For example, a metal blade (not shown) may be added to a distal end of the third tooth 124 or it may be added in a configuration that is substantially co-planar or substantially parallel planar configuration. If the third tooth 124 is plastic, the plastic material may be hard enough and sharp enough to pierce a metal can.

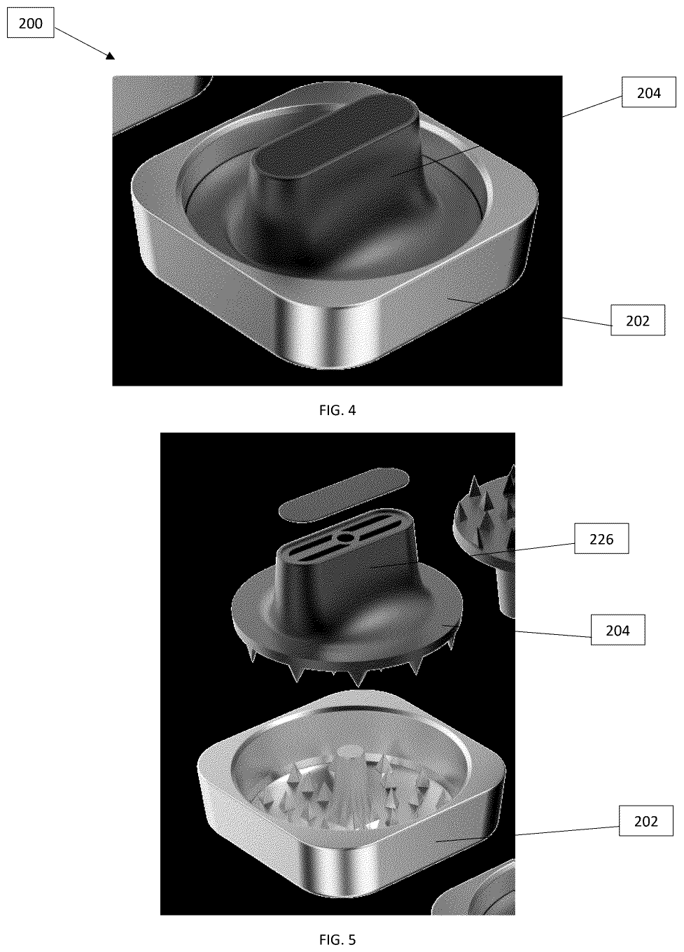

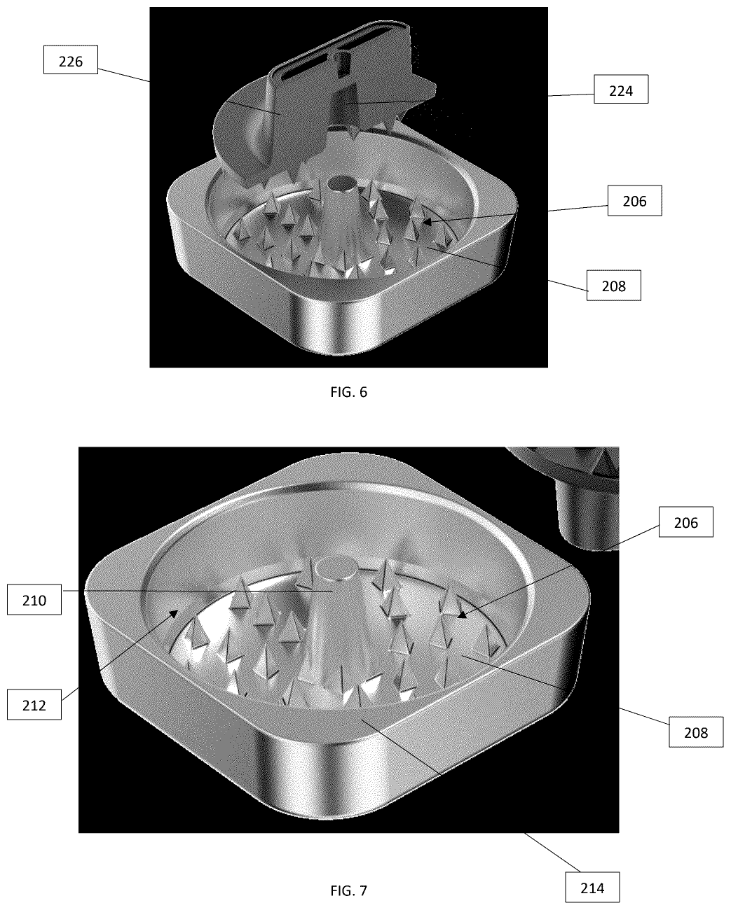

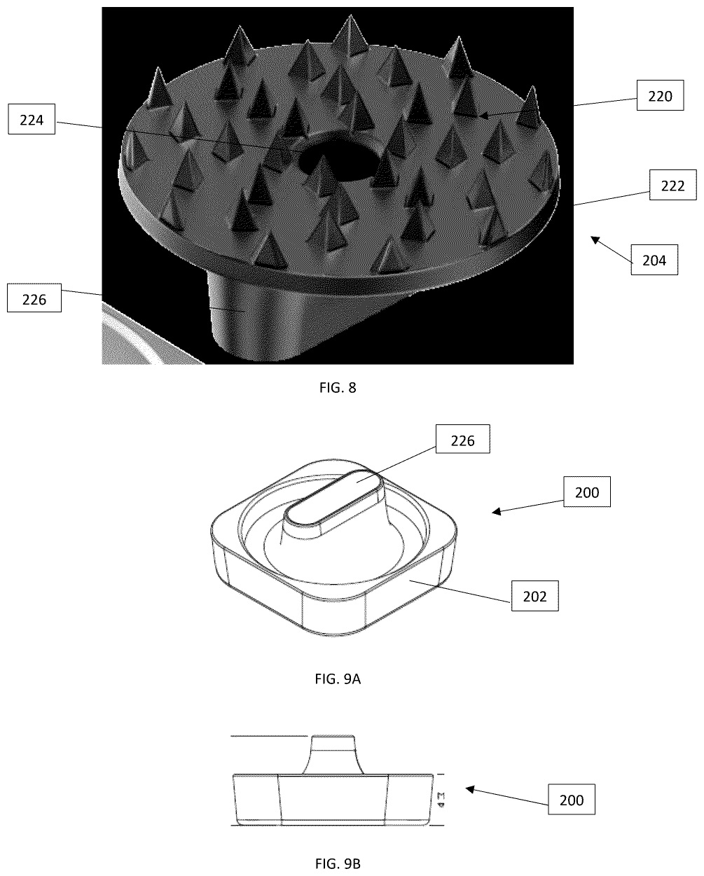

FIGS. 4, 5, 6, 7, 8, 9A and 9B illustrate a grinder 200 as a further embodiment of an accessory. The grinder 200 may include a first grinding section 202 and a second grinding section 204.

The first grinding section 202 may include a first plurality of teeth 206 on a first substrate 208. A post 210 may be at a center of the first grinding section 202. A receptacle 212 may be defined by the substrate 208 and a body 214 circumferentially attached to an edge of the substrate 208. The substrate 208 may be substantially planar, conical or semi-spherical.

The second griding section 204 may include a second plurality of teeth 220 on a second substrate 222. The second substrate 208 may be substantially planar, conical or semi-spherical to mirror the substrate 208, e.g., correspond in shape with the substrate 208. It is not necessary that the substrate 208 and the second substrate 222 correspond in shape with each other.

A post receptacle 224 may be at a center of the second grinding section 204 and may be configured to receive the post, and 210. A projection 226 may be on a side of the second substrate 222 that is opposite the second plurality of teeth 220. The projection 226 may be a handle or crank.

The first grinding section 202 may be magnetically coupled to the second grinding section 204. The post 210 may be magnetic and/or may include a magnetic material inside (e.g., the post may be plastic surrounding a magnet). The post receptacle 224 may be made entirely or partially of a ferrous material. The composition of the post 210 and post receptacle 224 may compel coupling between the first grinding section 202 and the second grinding section 204. The magnet/ferrous composition of the post 210 and post receptacle 224 may be reverse of that just described.

The first plurality of teeth 206 may be arranged on the first substrate 208 in a manner such that they do not interfere with a path of travel of the second plurality of teeth 220 when the second grinding section is rotated about its center within the first grinding section 202. For example, the first plurality of teeth may be arranged in rings about the center of the first grinding section 202 that are offset from a circular arrangement of the second plurality of teeth 220 of the second grinding section 204. However, the circular arrangement of teeth on the first grinding section 202 may be close enough in diameter to the circular arrangement on the second grinding section 204 so that material to be ground is squeezed between each of the pluralities of teeth.

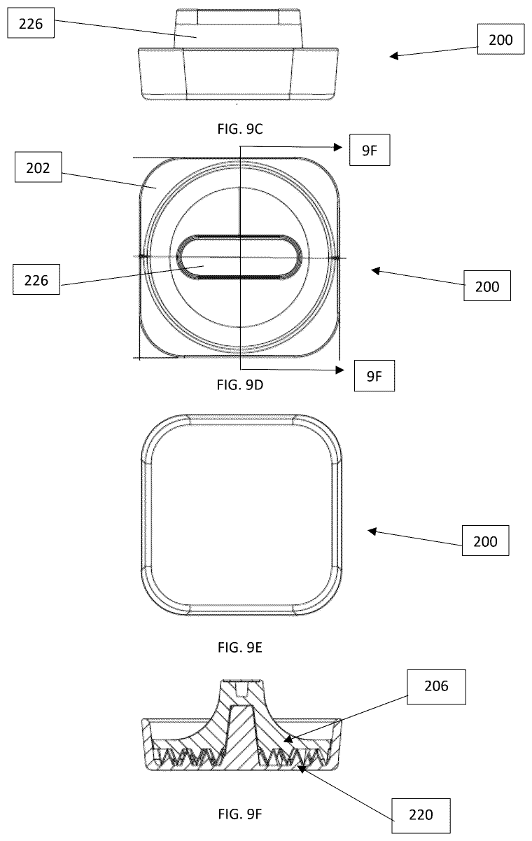

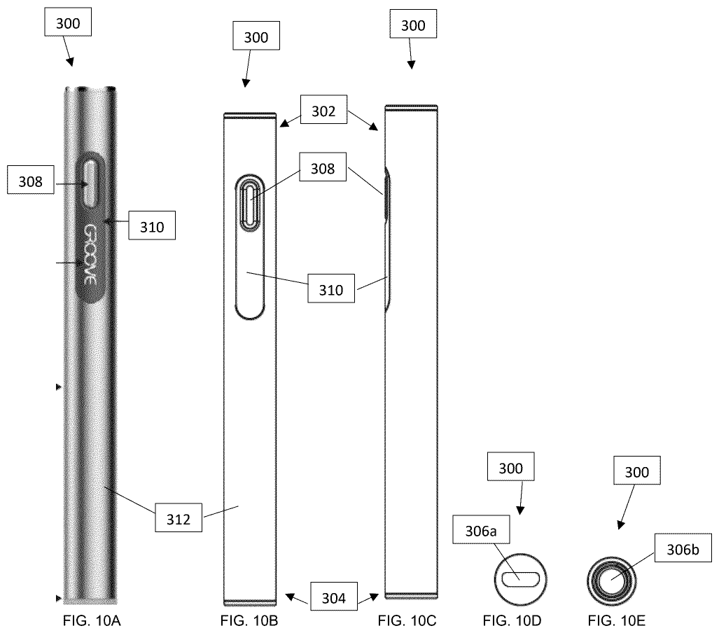

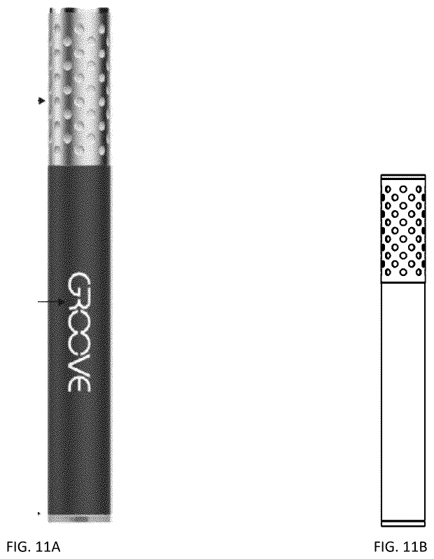

The teeth of the first grinding section 202 and the teeth of the second grinding section are configured to rotate three hundred and sixty degrees about the post 210 without physically interfering with each other. In that manner as shown in FIG. 9F, the space between teeth on the first grinding section 202 is at least as large as each tooth on the second grinding section 204 and vice versa. However, the teeth rotate closely enough to each other to grind down smoking materials. For example, the space between teeth during grinding may be as small as a half millimeter and in some embodiments as small as a tenth of a millimeter.

The first and second pluralities of teeth are illustrated as being pyramidal. However, the shape of the teeth is not limited thereto. The teeth may be cylindrical, rectangular, oval, etc. The sides of the teeth may be flat. However, all of the teeth of each of the plurality of teeth are not required to be flat. For example, some of the teeth may be curved.

FIG. 9A illustrates a perspective view of the grinder 200. FIG. 9B illustrates a front elevation view of the grinder 200. FIG. 9C illustrates a side elevation view of the grinder 200. FIG. 9D illustrates a top plan view of the grinder 200. FIG. 9E illustrates a illustrates a bottom plan view of the grinder 200. FIG. 9F illustrates a cross-sectional view of the grinder 200 as illustrated in FIG. 9D.

As illustrated in FIG. 9F, the grinder 200 may be configured such that the first grinding section 202 is configured to matingly engage the second grinding section 204 and so that the first plurality of teeth 206 couple to the second plurality of teeth 220. The first plurality of teeth 206 may be coupled to the second plurality of teeth 220 by a material to be ground.

A plurality of blades may be on at least one of the first plurality of teeth or the second plurality of teeth. The edges of each of the teeth may be a blade. For example, where a flat surface of each tooth connects with an adjacent surface of the tooth, the edge formed thereby may be sharp enough to act as a blade. Alternatively or additionally to the blades being on edges where sides of teeth meet, separate flat edges may be formed at each tooth edge, e.g., by milling, grinding, etc.

The grinder 200 may be hand operated by turning the second grinding section 204 relative to the first grinding section 202. The second grinding section 204 may be turned by gripping the projection 226 and turning the projection. The second grinding section 204 may also be rotated by a machine transmission, e.g., via a motor.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A multi-use tool, comprising:
a body having a first end and a second end;
a tube defined by the body and having an outlet at the first end of the body;
a second tube defined by the body between the first end and the second end and coupled to the tube;
a third tube at the first end defined by the body;
a first tool at the first end, the first tool configured to connect and secure the multi-use tool to an ancillary item; and
a second tool at the second end having a first tooth and a second tooth.

2. The multi-use tool of claim 1, further comprising:
a third tooth at the second end.

3. The multi-use tool of claim 2, wherein the third tooth is proximate to the first tooth and the second tooth.

4. The multi-use tool of claim 1, further comprising:
a ring encircled by the defined third tube.

5. The multi-use tool of claim 1, wherein the defined second tube is configured to be a receptacle for receiving a vaporizable material.

6. The multi-use tool of claim 5, wherein the body is configured to withstand temperatures of at least 100° F.

7. The multi-use tool of claim 1, wherein the defined third tube is substantially orthogonal to the defined first tube.

8. The multi-use tool of claim 7, wherein the defined third tube is substantially orthogonal to the defined second tube.
